(19) United States
(12) Patent Application Publication
(10) Pub. No.: US 2023/0207822 A1
(43) Pub. Date: Jun. 29, 2023

(54) COATED SULFUR PARTICLES WITH NO GAP

(71) Applicant: CONAMIX INC., Ithaca, NY (US)

(72) Inventors: Anqi Song, Ithaca, NY (US); Charles Hamilton, Ithaca, NY (US)

(21) Appl. No.: 17/432,390

(22) PCT Filed: Feb. 21, 2020
(86) PCT No.: PCT/US20/19136

§ 371 Date: Aug. 19, 2021

Related U.S. Application Data
(60) Provisional application No. 62/808,924, filed on Feb. 22, 2019.

(51) Int. Cl. H01M 4/62; H01M 4/38; H01M 4/04; H01M 10/052

(52) U.S. Cl. CPC H01M 4/624; H01M 4/38; H01M 4/0471; H01M 10/052; H01M 2004/028

(57) ABSTRACT

This application relates to secondary lithium-sulfur batteries with cathode materials comprising coated sulfur nanopartides.

### CROSS REFERENCE TO RELATED APPLICATIONS

This application claims priority to and benefit of U.S. Application Ser. No. 62/808,924, filed on Feb. 22, 2019, the contents of which is incorporated by reference in its entirety.

### TECHNICAL FIELD

This application relates to coated sulfur nanoparticles for secondary lithium-sulfur batteries.

### BACKGROUND

A major objective in the commercial development of next generation rechargeable batteries is to provide batteries with higher energy densities and lower cost than state of the art lithium-ion batteries. One of the most promising approaches to this goal is the use of a sulfur cathode coupled with a lithium metal anode. Sulfur is inexpensive, abundant, and offers a theoretical energy capacity that is an order of magnitude higher than conventional metal oxide-based intercalation cathodes used in current lithium ion cells. Similarly, anodes based on metallic lithium have a substantially higher energy density than lithium graphite anodes used in current lithium ion cells.

Although elemental sulfur has been under investigation as a battery cathode material for more than 50 years, fundamental problems have yet to be solved to enable widespread commercialization. Although incremental improvements in capacity and cycle lifetime of lithium sulfur batteries have been made, significant advances are needed to prevent polysulfide loss and to create system chemistries that are compatible with sulfur chemistry and lithium metal anodes. The present disclosure addresses these and related challenges.

### SUMMARY

Among other things, the present disclosure is directed to novel nanostructured materials for use in energy storage devices and related methods for fabricating and using such materials. In one aspect, the present disclosure is directed to nanostructured materials comprising core-shell structures. In certain embodiments, a core-shell structure has no gap between core and shell. Encompassed in the present invention is the recognition that, in certain embodiments, by producing nanostructured materials that are completely filled with sulfur (i.e. without a gap) higher energy densities are achieved. Higher energy densities are particularly desirable when, for example, nanoparticles are used in fabricating battery electrodes. In certain embodiments, the core comprises an electroactive sulfur material. In certain embodiments, an electroactive sulfur material is selected from the group consisting of elemental sulfur, sulfur-containing organic molecules, sulfur-containing polymers, sulfur-containing composites, or metal sulfides as well as combinations or composites of two or more of these. In certain embodiments, the shell comprises a polymer. In certain embodiments, the shell comprises an electrically conducting polymer. In certain embodiments, a polymer is selected from the group consisting of polyaniline, polythiophene, polyacetylene, polypyrrole, polydopamine, and the like. In certain embodiments, a shell comprises a vulcanized polymer. In certain such embodiments, a vulcanized polymer is selected from the group consisting of polyolefins, polyalkynes, polyaromatic and polyheteroaromatic polymers, and blends, mixtures, and co-polymers thereof. In certain embodiments, a vulcanized polymer is selected from a vulcanized composition derived from the group consisting of: polyaniline, polythiophene, polyacetylene, polypyrrole, polydopamine, and blends, mixtures, and co-polymers thereof. In certain such embodiments, a vulcanized polymer comprises vulcanized polyaniline. In certain such embodiments, a vulcanized polymer comprises vulcanized polythiophene. In certain such embodiments, a vulcanized polymer comprises vulcanized polypyrrole. In certain such embodiments, a vulcanized polymer comprises vulcanized polyacetylene. In certain such embodiments, a vulcanized polymer comprises vulcanized polydopamine. In certain such embodiments, a vulcanized polymer is selected from the group consisting of vulcanized polyaniline, vulcanized polythiophene, vulcanized polyacetylene, vulcanized polypyrrole, vulcanized polydopamine, and blends, mixtures, and co-polymers thereof.

In another aspect, the present disclosure is directed to cathode materials comprising nanostructured materials described herein, and lithium-sulfur batteries comprising said cathode materials.

In certain embodiments, a nanostructured material comprises encapsulated sulfur nanoparticles. In certain embodiments, an encapsulated sulfur nanoparticle is a sulfur nanoparticle coated with a vulcanized polymer shell. In certain such embodiments, a vulcanized polymer is in physical contact with a sulfur nanoparticle. For such coated sulfur particles (CSPs) there is essentially no gap separating the vulcanized polymer shell and the sulfur.

### DEFINITIONS

In this application, unless otherwise clear from context, the term “a” may be understood to mean “at least one.” As used in this application, the term “or” may be understood to mean “and/or.” In this application, the terms “comprising” and “including” may be understood to encompass itemized components or steps whether presented by themselves or together with one or more additional components or steps. As used in this application, the term “comprise” and variations of the term, such as “comprising” and “comprises,” are not intended to exclude other additives, components, integers or steps.

About, Approximately: As used herein, the terms “about” and “approximately” are used as equivalents. Unless otherwise stated, the terms “about” and “approximately” may be understood to permit standard variation as would be understood by those of ordinary skill in the art. Where ranges are provided herein, the endpoints are included. Any numerals used in this application with or without about/approximately are meant to cover any normal fluctuations appreciated by one of ordinary skill in the relevant art. In some embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Electroactive Sulfur: As used herein, the term “electroactive sulfur” refers to a sulfur that changes its oxidation state, or partakes in a formation or breaking of chemical bonds, in a charge-transfer step of an electrochemical reaction.

Polymer: As used herein, the term “polymer” generally refers to a substance that has a molecular structure consisting chiefly or entirely of repeated sub-units bonded together, such as synthetic organic materials used as plastics and resins.

Substantially: As used herein, the term “substantially” refers to the qualitative condition of exhibiting total or near-total extent or degree of a characteristic or property of interest.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the disclosed compositions and methods and are not intended as limiting. For purposes of clarity, not every component may be labeled in every drawing. In the following description, various embodiments are described with reference to the following drawings, in which:

FIG. 1 is a pictorial representation of a coated sulfur nanoparticle according to certain embodiments of the disclosure.

FIG. 2 is a pictorial representation and flow chart showing a method of fabricating a nanostructured material according to certain embodiments of the disclosure.

FIG. 3 is a pictorial representation of a cross section of an electrochemical cell according to certain embodiments of the disclosure.

FIG. 4 is a pictorial representation of a cylindrical battery embodying concepts of the disclosure.

FIG. 5 is a cryogenic-TEM image of coated sulfur nanoparticles according to certain embodiments of the disclosure.

FIG. 6 is a cryogenic-TEM image of coated sulfur nanoparticles according to certain embodiments of the disclosure.

FIG. 7 is an image depicting elemental mapping of coated sulfur nanoparticles according to certain embodiments of the disclosure, using Energy Dispersive X-ray Spectroscopy (EDS).

FIG. 8 is a graphical representation illustrating the thermogravimetric analysis of coated sulfur nanoparticles according to certain embodiments of the disclosure.

### DETAILED DESCRIPTION

Generally, the present disclosure is directed to novel nanostructured materials for use in secondary lithium-sulfur batteries and related methods for fabricating and using such devices. One of the most promising technologies developed for controlling sulfide migration out of the cathode has been the design of nanostructures to contain electroactive sulfur in the cathode, for example, by constructing nanoparticles with core-shell structures. Such particles mitigate sulfide shuttling between the cathode and anode by physically containing electroactive sulfur inside of an impermeable shell. In certain embodiments, novel nanostructured materials comprise core-shell nanoparticles. In certain embodiments, a core-shell structure has no gap between core and shell (e.g., there is no observable gap between the core and shell when characterized by cryogenic TEM). In certain embodiments, a core-shell structure comprises coated sulfur particles (CSPs). In certain embodiments, a core comprises an electroactive sulfur material. In certain embodiments, a core-shell structure comprises a polymer shell. In certain embodiments, a core-shell structure comprises an electrically conducting polymer shell. In certain embodiments, the present disclosure provides lithium-sulfur batteries, comprising coated sulfur particles as described herein as a cathode material.

### I. NANOSTRUCTURED MATERIALS

In one aspect, the present disclosure provides compositions comprising nanostructured materials that encompass a contained volume that is isolated from a volume outside of a nanostructured material by an encapsulating structure (e.g., a membrane). In certain embodiments, an encapsulating structure comprises: an inner surface in contact with a contained volume, an outer surface in contact with a volume outside of a nanostructured material.

Before describing the specific composition of the provided nanostructured materials, this section will describe general characteristics of nanostructures encompassed by the inventive concepts herein (e.g. the shape, size, and the arrangement of the components within the nanostructured materials).

Nanostructured materials of the present disclosure are not limited to any specific morphology. In certain embodiments, inventive nanostructures have a morphology that defines a contained interior volume that is physically isolated from the space outside of the nanostructured material. In certain embodiments, an interior volume of a nanostructure is separated from an exterior space by a shell. Nanostructured materials having such characteristics may take various morphological forms and the present disclosure places no particular limitations on the morphology of the nanostructured materials. Non-limiting examples of nanostructured materials that may be fashioned with an interior volume separated from an exterior volume include: core-shell particles, nanowires, nanostructured porous materials, closed-cell nanoporous foams, encapsulated nanocomposites, and related structures.

In certain embodiments, provided nanostructures comprise core-shell nanoparticles. Such nanoparticles comprise a substantially continuous shell that contains an internal volume and separates that volume from the space outside of the shell. In certain embodiments, such core shell particles are substantially spherical, though other geometries are also possible including: oblong or ovoid shapes, cylinders, prismatic shapes, irregular shapes, and polyhedral shapes. Optimal shape of nanoparticles may vary for different applications—while the descriptions and examples below concentrate on spherical core-shell nanoparticles as a way of demonstrating the broader principles of the invention, it is to be understood that these principles apply to nanostructured materials with other morphologies and that such alternatives are contemplated within the scope of certain embodiments of the disclosure. Control of nanoparticle morphology is well understood in the art (e.g. using techniques such as templating, surfactant control, mechanical processing, and the like) and it is therefore within the ability of the skilled person to adapt the concepts described herein with respect to spherical core-shell particles to other nanostructured materials.

Generally, the optimal dimensions of nanostructures may vary to suit a particular application. In various embodiments, a nanostructure is a nanoparticle (e.g. a material comprising discrete nanoscale particles). In certain embodiments, such nanoparticles have at least one dimension in the range of about 10 to about 1000 nm. In some embodiments, a nanostructured material does not comprise nanoscale particles per se but has nanoscale features, as for example in nanoporous or mesoporous solids which may be present as larger particles, monoliths, or composites which may be formed with nanoscale features or constituents.

In certain embodiments, provided nanostructures comprise substantially spherical nanoparticles with a diameter in the range of about 10 to about 5000 nm. In certain embodiments, such spherical particles have, on average, a diameter of less than about 100 nm—for example, provided nanoparticles may have diameters of 10 to 40 nm; 25 to 50 nm; or 50 to 100 nm. In certain embodiments, provided nanoparticles comprise spherical particles with a diameter less than about 500 nm—for example, provided nanoparticles may have diameters of 75 to 150 nm; 100 to 200 nm; 150 to 300 nm; 200 to 500 nm; or 300 to 500 nm. In certain embodiments, provided nanoparticles comprise spherical particles with a diameter less than about 1000 nm—for example, provided nanoparticles may have diameters of 200 to 600 nm; 500 to 800 nm; 600 to 800 nm; or 750 to 1000 nm. In certain embodiments, provided nanoparticles comprise spherical particles with a diameter between about 300 and 800 nm. In certain embodiments, provided nanoparticles comprise spherical particles with a diameter less than about 2000 nm—for example, provided nanoparticles may have diameters of 1000 to 1200 nm; 1000 to 1500 nm; 1300 to 1800; or 1500 to 2000 nm. In certain embodiments, provided nanoparticles comprise spherical particles with a diameter less than about 5000 nm—for example, provided nanoparticles may have diameters of 1000 to 2000 nm; 2000 to 3000 nm; 2500 to 3500 nm; 2000 to 4000 nm; or 3000 to 5000 nm.

In certain embodiments, provided nanoparticles comprise cylindrical particles with a cross-sectional diameter in the range of about 10 to about 1000 nm. In certain embodiments, such nanoparticles have a cross-sectional diameter of less than about 100 nm—for example, provided cylindrical particles may have diameters of 10 to 40 nm; 25 to 50 nm; or 50 to 100 nm. In certain embodiments, provided cylindrical particles have a cross-sectional diameter less than about 500 nm—for example, provided cylindrical particles may have diameters of 75 to 150 nm; 100 to 200 nm; 150 to 300 nm; 200 to 500 nm; or 300 to 500 nm. In certain embodiments, provided nanoparticles comprise cylinders with a cross-sectional diameter less than about 1000 nm—for example, provided nanoparticles may have diameters of 200 to 600 nm; 500 to 800 nm; 600 to 800 nm; or 750 to 1000 nm. In certain embodiments, provided nanoparticles comprise cylindrical particles with a diameter between about 100 and 400 nm. In certain embodiments, provided cylindrical particles have lengths greater than 1 μm. In certain embodiments, provided cylindrical nanoparticles have lengths greater than 5 μm, greater than 10 μm, greater than 20 μm, or greater than 50 μm. In certain embodiments, provided cylindrical nanoparticles have lengths of about 1 μm to about 1 cm. In certain embodiments, provided cylindrical nanoparticles have lengths of about 5 μm to about 1 cm. In certain embodiments, provided cylindrical nanoparticles have lengths of about 10 μm to about 1 cm. In certain embodiments, provided cylindrical nanoparticles have lengths of about 20 μm to about 1 cm. In certain embodiments, provided cylindrical nanoparticles have lengths of about 50 μm to about 1 cm. In certain embodiments, provided cylindrical nanoparticles have lengths of about 1 μm to about 1 mm. In certain embodiments, provided cylindrical nanoparticles have lengths of about 5 μm to about 1 mm. In certain embodiments, provided cylindrical nanoparticles have lengths of about 10 μm to about 1 mm. In certain embodiments, provided cylindrical nanoparticles have lengths of about 20 μm to about 1 mm. In certain embodiments, provided cylindrical nanoparticles have lengths of about 50 μm to about 1 mm. In certain embodiments, provided cylindrical nanoparticles have lengths of about 1 μm to about 100 μm. In certain embodiments, provided cylindrical nanoparticles have lengths of about 5 μm to about 100 μm. In certain embodiments, provided cylindrical nanoparticles have lengths of about 10 μm to about 100 μm. In certain embodiments, provided cylindrical nanoparticles have lengths of about 20 μm to about 100 μm. In certain embodiments, provided cylindrical nanoparticles have lengths of about 50 μm to about 100 μm. In certain embodiments, provided nanoparticles have an aspect ratio greater than 3, greater than 5, greater than 10, greater than 20. In certain embodiments, provided nanoparticles have an aspect ratio greater than 50, greater than 100, greater than 200, greater than 500, or greater than 1000.

In certain embodiments where the provided nanoparticles comprise a structure which separates an internal volume contained within the nanoparticle from a volume outside the nanoparticle (e.g. a shell or wall), such a structure may have a thickness of between about 0.5 and about 100 nm. The optimal thickness of such a structure will vary depending on the material from which it is made, the dimensions of the nanostructure of which it is a part, and/or the specific application for which the nanoparticle is being engineered. In certain embodiments, provided nanoparticles have a shell or wall thickness less than about 15 nm—for example, having a thickness in the range of about 1 to about 2 nm; about 2 to about 5 nm; about 5 to about 7 nm; about 5 to about 10 nm; or about 10 to about 15 nm. In certain embodiments, provided nanoparticles have a shell or wall thickness less than about 25 nm. In certain embodiments, provided nanoparticles have a shell or wall thickness less than about 50 nm—for example, having a thickness in the range of about 5 to about 15 nm; about 10 to about 20 nm; about 15 to about 30 nm; about 25 to about 40 nm; or about 30 to about 50 nm. In certain embodiments, provided nanoparticles have a shell or wall thickness less than about 75 nm. In certain embodiments, provided nanoparticles have a shell or wall thickness less than about 100 nm—for example, having a thickness in the range of about 50 to about 60 nm; about 50 to about 75 nm; about 60 to about 80 nm; or about 75 to about 100 nm.

It will be appreciated that a given combination of the particle shape, particle dimensions and wall thickness will together determine size of an internal volume enclosed within a particle (enclosed volume'). Shape of an enclosed volume may therefore be dictated by morphology of a nanostructured material. In various embodiments, an enclosed volume may comprise a single chamber, or it may comprise a plurality of smaller spaces that are isolated from each other or that have varying degrees of interconnectedness.

### A. Polymer Shell

As described above, certain nanostructured materials of the present disclosure are characterized in that they incorporate polymer compositions. In certain embodiments, such polymer compositions are incorporated into nanostructured materials as polymeric coatings on electroactive substances. In certain embodiments, such polymers are present in the shells of core shell particles.

The present disclosure places no particular restriction on composition of polymer shells described herein. Particularly useful aspects of a composition include, for example, physical and chemical compatibility with electrolytes, active species, additives, and solutes that will be encountered in electrochemical devices to which nanostructured materials are to be applied.

In certain embodiments, nanostructured materials of the present disclosure comprise electrically conducting polymers. In certain embodiments, nanostructured materials of the present disclosure comprise polymers selected from the group consisting of: polyheterocycles, poly-enes, and polyarenes. In certain embodiments, nanostructured materials of the present disclosure comprise polymers selected from the group consisting of: polyaniline, polydopamine, polypyrrole, polyselenophene, polythiophene, polynaphthalene, polyphenylene sulfide, and derivatives, mixtures or copolymers of any of these. In certain embodiments, nanostructured materials of the present disclosure comprise polymers selected from the group consisting of: polypyrrole (PPy), polythiophene (PTh), polydopamine, poly(3,4-ethylenedioxythiophene) (PEDOT), poly(3,4-propylenedioxythiophene) (ProDOT), poly(3,4-ethylenedioxypyrrole) (PEDOP), poly(3,4-propylenedioxypyrrole) (ProDOP), poly(3,4-ethylenedithiopyrrole) (PEDTP), poly(3,4-ethyleneoxyhiathiophene) (PEOTT), poly(3,4-ethylenedioxyselenophene) (PEDOSe), and derivatives, mixtures or copolymers of any of these. In certain embodiments, nanostructured materials of the present disclosure comprise polymers selected from the group consisting of: polyaniline (PAni), poly-N-methylaniline, poly(o-methylaniline) (POTO), poly(o-methoxyaniline) (POAS), poly(2,5-dimethylaniline) (PDMA), poly(2,5-dimethoxyaniline) (PDOA), sulfonated polyaniline (SPAN), poly(1-aminonaphthalene) (PNA), poly(5-aminonaphthalene-2-sulfonic acid) polyphenylene sulfide, and derivatives, mixtures or copolymers of any of these.

In certain embodiments, a nanostructured material comprises a composite of a polymer and an inorganic material such as, for example, metals, metal alloys, metal oxides, metal sulfides, elemental carbon, silicon, and silicon carbide. In certain embodiments, an inorganic compositing material is selected from: aluminum oxide, aluminum sulfide, silicon oxide, iron oxide, manganese oxide, titanium disulfide, molybdenum disulfide, copper sulfide, germanium disulfide, zirconium oxide, titanium oxide, and zeolites.

In another embodiment, a nanostructured material according to the present disclosure comprises a polymer with dispersed organic or inorganic matrices in the form of nano-sized powdered solids present at amounts up to 80 wt % of the polymer. Carbon matrices can be prepared by pyrolysis of any suitable material as described in U.S. Pat. No. 6,585,802. Zeolites prepared as described in U.S. Pat. No. 6,755,900 may also be used as an inorganic matrix. In at least one embodiment, matrices comprise particles less than about 50 nanometers in diameter, for example less than about 40 nm, less than about 25 nm, less than about 20 nm, less than about 10 nm, less than about 5 nm, less than about 2 nm, or less than 1 nm in diameter.

In certain embodiments, a nanostructured material comprises one or more polymers selected from the group consisting of: polyethylene, polypropylene, polytetrafluoroethylene (PTFE), polyvinylidene difluoride (PVDF), polysulfone, polyethersulfone, polyacrylonitrile, polyamide, polyimide, polyamideimide, polyetherimide, polyether, cellulose acetate, polyaniline, polypyrrole, polyetheretherketone (PEEK), polybenzimidazole, and composites thereof. A polymer composite can be made by any technique known in the art, including in situ polymerization, solution coating, sintering, stretching, track etching, template leaching, interfacial polymerization, or phase inversion.

In certain embodiments, a nanostructured material according to the present disclosure comprises a plurality of polymer layers. In certain embodiments, a nanostructured material is a polymer shell comprising two polymer layers. In certain embodiments, a polymer shell comprises three polymer layers.

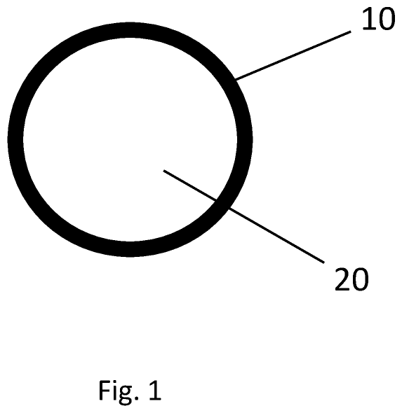

In certain embodiments, a nanostructured material comprises encapsulated sulfur nanoparticles, wherein a sulfur nanoparticle is coated with a vulcanized polymer shell. In certain such embodiments, a vulcanized polymer is in physical contact with a sulfur nanoparticle. Sulfur nanoparticles are encapsulated, each nanoparticle being coated with a vulcanized polymer shell. The polymer shell and the encapsulated sulfur are in physical contact with each other. For such coated sulfur particles (CSPs) there is essentially no gap separating the polymer shell and the sulfur. This gap-free encapsulation is schematically illustrated in FIG. 1, which shows how the polymer shell 10 in intimate contact with the interior sulfur nanoparticle 20. In certain such embodiments, a vulcanized polymer shell is selected from the group consisting of polyolefins, polyalkynes, polyaromatic and polyheteroaromatic polymers, and blends, mixtures, and co-polymers thereof. In certain embodiments, a vulcanized polymer shell is selected from a vulcanized composition derived from the group consisting of: polyaniline, polythiophene, polyacetylene, polypyrrole, polydopamine, and blends, mixtures, and co-polymers thereof. In certain such embodiments, a vulcanized polymer shell comprises vulcanized polyaniline. In certain such embodiments, a vulcanized polymer shell comprises vulcanized polythiophene. In certain such embodiments, a vulcanized polymer shell comprises vulcanized polypyrrole. In certain such embodiments, a vulcanized polymer shell comprises vulcanized polyacetylene. In certain such embodiments, a vulcanized polymer shell comprises vulcanized polydopamine. In certain such embodiments, a vulcanized polymer shell is selected from the group consisting of vulcanized polyaniline, vulcanized polythiophene, vulcanized polyacetylene, vulcanized polypyrrole, vulcanized polydopamine, and blends, mixtures, and co-polymers thereof.

By producing nanoparticles that are completely filled with sulfur (i.e. without a gap) higher energy densities can be achieved. Among other advantages, higher energy densities are particularly desirable when the nanoparticles are used in fabricating battery electrodes. It is appreciated that providing more sulfur in each particle can lead to shell breakage and lower performing cycle life, since there is less room for sulfur expansion during electrode cycling. Encompassed in the present disclosure is the recognition that, in some embodiments, vulcanization of a polymer and/or polymer shell improves strength and flexibility of said polymer/polymer shell. Without wishing to be bound by any particular theory, it is believed that a coated sulfur particle with a vulcanized polymer shell is more robust (e.g., stronger and/or more flexible) than a coated sulfur particle with a polymer shell that is not vulcanized. For example, in certain embodiments, a provided coated sulfur particle (i.e., without a gap) with a vulcanized polymer shell is resistant to shell breakage during electrode cycling. In certain such embodiments, a coated sulfur particle with a vulcanized polymer shell is more resistant to shell breakage than a coated sulfur particle with a polymer shell that is not vulcanized. In certain embodiments, a vulcanized polymer shell of a coated sulfur particle used in the preparation of a cathode material is able to flex to accommodate changes in sulfur volume during electrode cycling.

### B. Contained Electroactive Substance

As described above, in certain embodiments, in addition to polymer compositions described herein, nanostructured materials of the present disclosure comprise electroactive substances. In certain embodiments, such electroactive substances have a morphology controlled by a nanostructured polymeric material. In certain embodiments, an electroactive substance is contained within an enclosed volume that is separated from space outside of a nanostructured material by a structure comprising a polymer. In certain embodiments, an electroactive substance is contained in a shell comprising a polymer. In certain embodiments there is essentially no gap separating a polymer shell and a contained electroactive substance (e.g., there is no observable gap between polymer shell and contained electroactive substance when characterized by cryogenic TEM).

Such electroactive substances undergo electrochemical reactions and provide electrical capacity to devices fabricated from provided nanostructured materials. These substances are referred to generically herein as ‘contained electroactive materials’. In certain embodiments, provided nanostructured materials comprise solid electroactive materials, which are contained within an enclosed volume. In certain embodiments, a contained electroactive material may be a liquid or may be dissolved in a liquid phase.

In embodiments where contained electroactive materials are solids, they may be referred to generically as ‘contained electroactive solids’. Such solids have a composition different from solid substance(s) comprising polymer shells of nanostructured materials described herein. No specific limitations are placed on shape of such contained electroactive solids or their distribution within a nanostructured material. In certain embodiments, an electroactive solid is contained within a particle. In certain embodiments, a contained electroactive substance is in physical contact or is wholly or partially adhered to a nanostructured material. In certain embodiments, a contained electroactive substance is present as a coating on a surface in a nanostructured material. It is noteworthy that electroactive solids may be produced or manufactured with a particular shape or arrangement within a nanostructured material, but that these may change during operation (e.g. charge or discharge) of an electrochemical device comprising electroactive material.

In certain embodiments, a contained electroactive solid is present in a form having at least one dimension with a length in a range of about 5 nm to about 3,000 nm. In certain embodiments, a contained electroactive solid is present in a form having at least one dimension with a length in a range of about 10 nm to about 50 nm, about 30 nm to about 100 nm, about 100 nm to about 500 nm, or about 500 nm to about 1000 nm. In certain embodiments, a contained electroactive solid is present in a form having at least one dimension with a length in a range of about 1000 nm to about 1500 nm, about 1000 nm to about 2000 nm, about 1500 nm to about 3000 nm, or about 2000 nm to about 3000 nm.

In certain embodiments, a contained electroactive solid comprises sulfur, and nanostructured materials have utility as cathode materials for sulfur batteries. Such compositions comprise an electroactive sulfur-based material. Examples of suitable electroactive sulfur materials include elemental sulfur, sulfur-containing organic molecules, sulfur-containing polymers, sulfur-containing composites, or metal sulfides, as well as combinations or composites of two or more of these. In certain embodiments, an electroactive sulfur material is selected from the group consisting of: elemental sulfur, lithium sulfide, and a sulfur-containing polymer, or combinations thereof.

In certain embodiments, an electroactive sulfur is present in the form of elemental sulfur. In certain embodiments, an electroactive sulfur material comprises S₈.

In certain embodiments, an electroactive sulfur is present as a metal sulfide. In certain embodiments, a metal sulfide comprises an alkali metal sulfide; in certain embodiments, a metal sulfide comprises lithium sulfide.

In certain embodiments, the electroactive sulfur does not comprise Li₂S.

In certain embodiments, an electroactive sulfur material is present as a composite with another material. Such composites may include materials such as graphite, graphene, metals, metal alloys, metal sulfides or oxides, or conductive polymers. In certain embodiments, sulfur may be alloyed with other chalcogenides, such as selenium or arsenic.

Generally, dimensions and shape of an electroactive sulfur-based material in a cathode composition may be varied to suit a particular application and/or be controlled as a result of morphology of a nanostructure comprising electroactive sulfur. In various embodiments, an electroactive sulfur-based material is present as a nanoparticle. In certain embodiments, such electroactive sulfur-based nanoparticles have a spherical or spheroid shape. In certain embodiments, nanostructured materials of the present disclosure comprise substantially spherical sulfur-containing particles with a diameter in a range of about 50 nm to about 1200 nm. In certain embodiments, such particles have a diameter in a range of about 50 nm to about 250 nm, about 100 nm to about 500 nm, about 200 nm to about 600 nm, about 400 nm to about 800 nm, or about 500 nm to about 1000 nm.

Such nanoparticles may have various morphologies as described above. In certain embodiments, an electroactive sulfur-based material is present as a core of a core-shell particle (e.g., where there is no gap between sulfur-based core and shell when characterized by cryogenic TEM).

### II. METHODS OF PREPARING NANOSTRUCTURED MATERIALS

In another aspect, the present disclosure provides methods of manufacturing provided nanostructured materials. The art of nanomaterial synthesis and engineering is well advanced and the skilled artisan will be familiar with bountiful literature teaching methods to make nano-sized structures suitable for application to the present disclosure, including methods for making materials where an electroactive substance is contained within a volume defined by a nanostructure. Among other things, the present disclosure provides methods to produce nanostructured materials. For example, in certain embodiments, the present disclosure relates to a method for fabricating a nanostructured material, comprising a polymer and an electroactive sulfur composition.

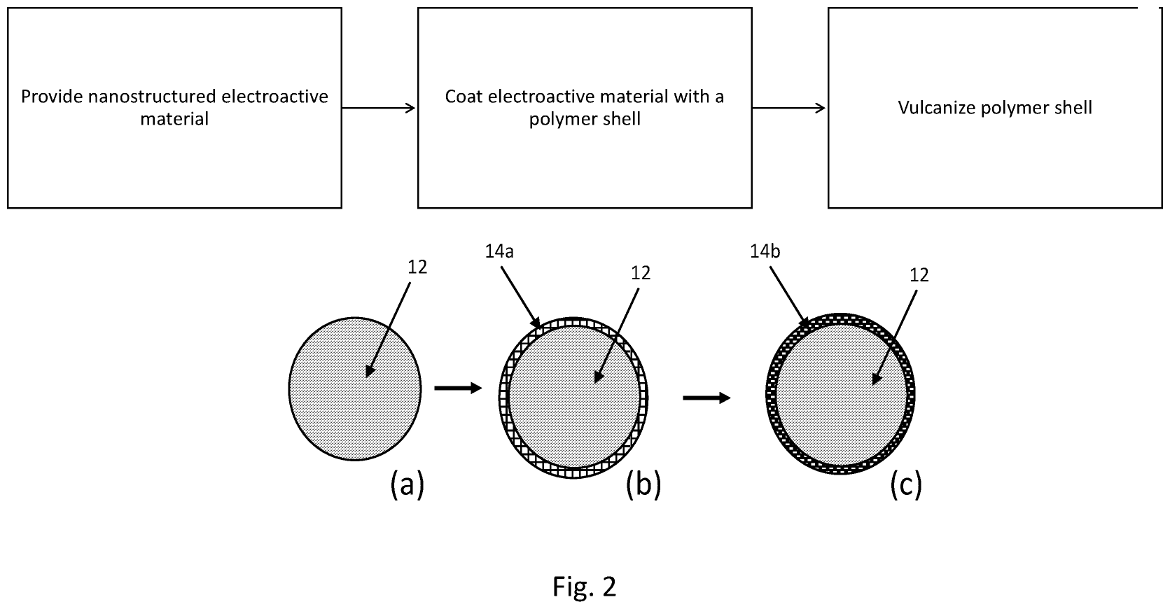

FIG. 2 depicts a method of manufacturing core-shell nanoparticles in accordance with certain embodiments of the present disclosure.

One approach to producing nanostructured materials, illustrated in FIG. 2, comprises steps of:

a) providing a nanostructured electroactive sulfur material 12;

b) contacting nanostructured electroactive sulfur material 12 with a polymerization mixture, comprising a mixture of co-monomers, under conditions that promote polymerization to produce a polymer shell 14a (e.g., polymer compositions described hereinabove);

c) vulcanizing the polymer shell by cross-linking the polymer with sulfur from the electroactive sulfur material, such that after vulcanization there is no gap between the electroactive sulfur material and the vulcanized polymer shell 14b (e.g., no observable gap when characterized by cryogenic TEM).

The approach depicted in FIG. 2 can be used to produce core-shell sulfur nanoparticles with, for example, PAni (polyaniline) shells. In certain embodiments, a method of producing nanostructured materials may comprise steps of: providing an elemental sulfur nanoparticle; suspending a sulfur nanoparticle in a dilute aqueous acid solution (e.g. dilute sulfuric acid) containing aniline; adding to the suspension an oxidant (e.g. potassium peroxidisulfate) to form a mixture; stirring the mixture for a period of time sufficient to form a polymer shell, surrounding a sulfur containing core to form a coated sulfur nanoparticle; and heating the coated sulfur nanoparticle to vulcanize the polymer shell. Alternatively, in certain embodiments, an electroactive sulfur nanoparticle may be contacted with pre-formed polymer under conditions that promote coating of a nanoparticle by the polymer to form a polymer shell.

In certain embodiments, a coated sulfur nanoparticle is heated to a temperature within a range of about 80° C. to about 400° C. to vulcanize a polymer shell. In certain embodiments, a coated sulfur nanoparticle is heated to a temperature within a range of about 80° C. to about 200° C. to vulcanize a polymer shell. In certain embodiments, a coated sulfur nanoparticle is heated to a temperature within a range of about 80° C. to about 150° C. to vulcanize a polymer shell. In certain embodiments, a coated sulfur nanoparticle is heated to a temperature within a range of about 100° C. to about 400° C. to vulcanize a polymer shell. In certain embodiments, a coated sulfur nanoparticle is heated to a temperature within a range of about 100° C. to about 300° C. to vulcanize a polymer shell. In certain embodiments, a coated sulfur nanoparticle is heated to a temperature within a range of about 110° C. to about 250° C. to vulcanize a polymer shell. In certain embodiments, a coated sulfur nanoparticle is heated to a temperature within a range of about 150° C. to about 400° C. to vulcanize a polymer shell. In certain embodiments, a coated sulfur nanoparticle is heated to a temperature within a range of about 150° C. to about 250° C. to vulcanize a polymer shell. In certain embodiments, a coated sulfur nanoparticle is heated to a temperature within a range of about 200° C. to about 400° C. to vulcanize a polymer shell. In certain embodiments, a coated sulfur nanoparticle is heated to a temperature within a range of about 300° C. to about 400° C. to vulcanize a polymer shell.

In certain embodiments, a coated sulfur nanoparticle is heated for about 0.2 to about 48 hours to vulcanize a polymer shell. In certain embodiments, a coated sulfur nanoparticle is heated for about 0.2 to about 24 hours to vulcanize a polymer shell. In certain embodiments, a coated sulfur nanoparticle is heated for about 0.2 to about 12 hours to vulcanize a polymer shell. In certain embodiments, a coated sulfur nanoparticle is heated for about 1 to about 12 hours to vulcanize a polymer shell. In certain embodiments, a coated sulfur nanoparticle is heated for about 8 to about 48 hours to vulcanize a polymer shell. In certain embodiments, a coated sulfur nanoparticle is heated for about 12 to about 48 hours to vulcanize a polymer shell. In certain embodiments, a coated sulfur nanoparticle is heated for about 24 to about 48 hours to vulcanize a polymer shell. In certain embodiments, a coated sulfur nanoparticle is heated for about 8 to about 36 hours to vulcanize a polymer shell. In certain embodiments, a coated sulfur nanoparticle is heated for about 12 to 36 about hours to vulcanize a polymer shell.

In certain embodiments, a coated sulfur nanoparticle is heated to a temperature within a range of about 80° C. to about 400° C. for about 0.2 to about 48 hours to vulcanize a polymer shell. In certain embodiments, a coated sulfur nanoparticle is heated to a temperature within a range of about 80° C. to about 300° C. for about 8 to about 48 hours to vulcanize a polymer shell. In certain embodiments, a coated sulfur nanoparticle is heated to a temperature within a range of about 150° C. to about 400° C. for about 0.2 to about 24 hours to vulcanize a polymer shell.

While FIG. 2 illustrates spherical core-shell particles, it will be recognized that a similar process can be utilized for electroactive substances having other morphologies (e.g. an electroactive nanowire, nano-scale platelet or the like could be substituted for the nanosphere) to provide other structured nanomaterials with similar operational characteristics.

While core-shell particles of the present disclosure have been primarily described with respect to PAni-based shells, alternative categories of conductive polymers are contemplated and considered within the scope of the present disclosure. Such alternatives include polyheterocycles, such as polythiophenes, polypyrrole, poly(3,4-ethylenedioxythiophene) (PEDOT), poly(3,4-ethylenedioxypyrrole) (PEDOP), as well conductive poly-enes and polyarenes (e.g., polystyrene sulfonate). Polymer shells are preferably conductive within the operating voltage range of Li/S batteries (e.g., 1.5-2.4 V). For structures of additional conductive polymers, refer to Synthesis, processing and material properties of conjugated polymers, Polymer, Vol. 37, No. 22, pp. 5017-5047, 1996, the entire disclosure of which is incorporated by reference herein.

### III. ELECTRODE COMPOSITIONS AND ELECTROCHEMICAL CELLS

### C. Cathode

As mentioned above, nanostructured materials of the present disclosure have utility in manufacture of electrochemical devices. Generally, nanostructured materials disclosed herein would be physically combined with other materials to create formulated mixtures which have utility for manufacture of electrodes for electrochemical devices and, in particular, mixtures useful for forming cathodes in secondary lithium-sulfur batteries. In one aspect, the present disclosure provides such cathode compositions (e.g., mixtures). Typically, provided mixtures will include one or more of a nanostructured material described hereinabove (e.g., core-shell particles, etc.), in addition to additives such as electrically conductive particles, binders, and other functional additives typically found in battery cathode mixtures. Generally, provided cathode mixtures include plentiful conductive particles to increase electrical conductivity of a cathode and provide a low resistance pathway for electrons to access a manufactured cathode. In various embodiments, other additives may be included to alter or otherwise enhance a prepared cathode. Generally, such mixtures will comprise at least 50 wt. % of a nanostructured material. In certain embodiments, such mixtures comprise at least about 60 wt. %, at least about 75 wt. %, at least about 80 wt. %, at least about 85 wt. %, or at least about 90 wt. % of a nanostructured material. In certain embodiments, such mixtures will comprise about 50 to about 90 wt. % of a nanostructured material. In certain embodiments, such mixtures will comprise about 60 to about 90 wt. % of a nanostructured material. In certain embodiments, such mixtures will comprise about 60 to about 80 wt. % of a nanostructured material. In certain embodiments, such mixtures will comprise about 70 to about 90 wt. % of a nanostructured material. In certain embodiments, such mixtures will comprise about 75 to about 85 wt. % of a nanostructured material.

In certain embodiments, a cathode of a secondary lithium-sulfur battery comprises a positive active material and a conductive material. In certain embodiments, a cathode of a lithium-sulfur battery comprises a positive active material, a conductive material, and a binder. In certain embodiments, a positive active material is electroactive sulfur. In certain embodiments, electroactive sulfur comprises coated sulfur nanoparticles described herein. In certain embodiments, electroactive sulfur in such sulfur nanoparticles is selected from the group consisting of elemental sulfur (S₈), a sulfur-based compound, a sulfur-containing polymer, or combinations thereof. In certain embodiments, a sulfur-based compound is selected from the group consisting of Li₂Sₙ (n≥1), organic-sulfur compounds, and carbon-sulfur polymers ((C₂Sₓ)ₙ where x=2.5 to 50 and n≥2). In certain embodiments, electroactive sulfur in sulfur nanoparticles of a lithium-sulfur battery comprises elemental sulfur. In certain embodiments, electroactive sulfur in sulfur nanoparticles of a lithium-sulfur battery comprises a sulfur-containing polymer.

In certain embodiments, a conductive material comprises an electrically conductive material that facilitates movement of electrons within a cathode. For example, in certain embodiments, a conductive material is selected from the group consisting of carbon-based materials, graphite-based materials, conductive polymers, and combinations thereof. In certain embodiments, a conductive material comprises a carbon-based material. In certain embodiments, a conductive material comprises a graphite-based material. For example, in certain embodiments, an electrically conductive material is selected from the group consisting of conductive carbon powders, such as carbon black, Super P®, C-NERGY™ Super C65, Ensaco® black, Ketjenblack®, acetylene black, synthetic graphite such as Timrex® SFG-6, Timrex® SFG-15, Timrex® SFG-44, Timrex® KS-6, Timrex® KS-15, Timrex® KS-44, natural flake graphite, carbon nanotubes, fullerenes, hard carbon, mesocarbon microbeads, and the like. In certain embodiments, a conductive material comprises one or more conductive polymers. For example, in certain embodiments, a conductive polymer is selected from the group consisting of polyaniline, polythiophene, polyacetylene, polypyrrole, polydopamine, and the like. In certain embodiments, a conductive material is used alone. In other embodiments, a conductive material is used as a mixture of two or more conductive materials described above.

In certain embodiments, a binder is adhered to a positive active material on a current collector. Typical binders include polyvinylidene fluoride, poly(vinylidene fluoride-co-hexafluoropropene) (PVDF/HFP), Polytetrafluoroethylene (PTFE), Kynar Flex® 2801, Kynar® Powerflex LBG, Kynar® HSV 900, Teflon®, carboxymethylcellulose, styrene-butadiene rubber (SBR), polyethylene oxide, polypropylene oxide, polyethylene, polypropylene, polyacrylates, polyvinyl pyrrolidone, poly(methyl methacrylate), polyethyl acrylate, polytetrafluoroethylene, polyvinyl chloride, polyacrylonitrile, polycaprolactam, polyethylene terephthalate, polybutadiene, polyisoprene or polyacrylic acid, or derivatives, mixtures, or copolymers of any of these. In some embodiments, a binder is water soluble binder, such as sodium alginate or carboxymethyl cellulose. Generally, binders hold active materials together and in contact with a current collector (e.g., aluminum foil or copper foil). In certain embodiments, a binder is selected from the group consisting of poly(vinyl acetate), polyvinyl alcohol, polyethylene oxide, polyvinyl pyrrolidone, alkylated polyethylene oxide, crosslinked polyethylene oxide, polyvinyl ether, poly(methyl methacrylate), polyvinylidene fluoride, a copolymer of polyhexafluoropropylene and polyvinylidene fluoride, polyethyl acrylate, polytetrafluoroethylene, polyvinyl chloride, polyacrylonitrile, polyvinyl pyridine, polystyrene, and derivatives, mixtures, and copolymers thereof.

In certain embodiments, a cathode further comprises a coating layer. For example, in certain embodiments, a coating layer comprises a polymer, an inorganic material, or a mixture thereof. In certain such embodiments, a polymer is selected from the group consisting of polyvinylidene fluoride, a copolymer of polyvinylidene fluoride and hexafluoropropylene, poly(vinyl acetate), poly(vinyl butyral-co-vinyl alcohol-co-vinyl acetate), poly(methylmethacrylate-co-ethyl acrylate), polyacrylonitrile, polyvinyl chloride-co-vinyl acetate, polyvinyl alcohol, poly(l-vinylpyrrolidone-co-vinyl acetate), cellulose acetate, polyvinyl pyrrolidone, polyacrylate, polymethacrylate, polyolefin, polyurethane, polyvinyl ether, acrylonitrile-butadiene rubber, styrene-butadiene rubber, acrylonitrile-butadiene styrene, a sulfonated styrene/ethylene-butylene/styrene triblock copolymer, polyethylene oxide, and derivatives, mixtures, and copolymers thereof. In certain such embodiments, an inorganic material comprises, for example, colloidal silica, amorphous silica, surface-treated silica, colloidal alumina, amorphous alumina, tin oxide, titanium oxide, titanium sulfide (TiS₂), vanadium oxide, zirconium oxide (ZrO₂), iron oxide, iron sulfide (FeS), iron titanate (FeTiO₃), barium titanate (BaTiO₃), and combinations thereof. In certain embodiments, an organic material comprises conductive carbon.

In certain embodiments, provided mixtures can be formulated without a binder, which can be added during manufacture of electrodes (e.g. dissolved in a solvent used to form a slurry from a provided mixture). In embodiments where binders are included in a provided mixture, a binder can be activated when made into a slurry to manufacture electrodes.

Suitable materials for use in cathode mixtures include those disclosed in Cathode Materials for Lithium Sulfur Batteries: Design, Synthesis, and Electrochemical Performance, Lianfeng, et al., Interchopen.com, published Jun. 1, 2016, and The Strategies of Advanced Cathode Composites for Lithium-Sulfur Batteries, Zhou et al., SCIENCE CHINA Technological Sciences, Volume 60, Issue 2: 175-185(2017), the entire disclosures of each of which are hereby incorporated by reference herein.

### D. Anode

In certain embodiments, a lithium-sulfur battery comprises a lithium anode. Any lithium anode suitable for use in lithium-sulfur cells may be used. In certain embodiments, an anode of a lithium-sulfur battery comprises a negative active material selected from materials in which lithium intercalation reversibly occurs, materials that react with lithium ions to form a lithium-containing compound, metallic lithium, lithium alloys, and combinations thereof. In certain embodiments, an anode comprises metallic lithium. In certain embodiments, lithium-containing anodic compositions comprise carbon-based compounds. In certain embodiments, a carbon-based compound is selected from the group consisting of crystalline carbon, amorphous carbon, graphite, and mixtures thereof. In certain embodiments, a material that reacts with lithium ions to form a lithium-containing compound is selected from the group consisting of tin oxide (SnO₂), titanium nitrate, and silicon. In certain embodiments, a lithium alloy comprises an alloy of lithium with another alkali metal (e.g. sodium, potassium, rubidium or cesium). In certain embodiments, a lithium alloy comprises an alloy of lithium with a transition metal. In certain embodiments, lithium alloys include alloys of lithium and a metal selected from the group consisting of Na, K, Rb, Cs, Fr, Be, Mg, Ca, Sr, Ba, Ra, Al, Sn, and combinations thereof. In certain embodiments, a lithium alloy comprises an alloy of lithium with indium. In certain embodiments, an anode comprises a lithium-silicon alloy. Examples of suitable lithium-silicon alloys include: Li₁₅Si₄, Li₁₂Si₇, Li₇Si₃, Li₁₃Si₄, and Li₂₁Si₅/Li₂₂Si₅. In certain embodiments, a lithium metal or lithium alloy is present as a composite with another material. In certain embodiments, such composites include materials such as graphite, graphene, metal sulfides or oxides, or conductive polymers.

An anode may be protected against redox shuttling reactions and hazardous runaway reactions by any of the methodologies reported in the art, for example, by creating a protective layer on a surface of an anode by chemical passivation or polymerization. For example, in certain embodiments, an anode comprises an inorganic protective layer, an organic protective layer, or a mixture thereof, on a surface of lithium metal. In certain embodiments, an inorganic protective layer comprises Mg, Al, B, Sn, Pb, Cd, Si, In, Ga, lithium silicate, lithium borate, lithium phosphate, lithium phosphoronitride, lithium silicosulfide, lithium borosulfide, lithium aluminosulfide, lithium phosphosulfide, lithium fluoride or combinations thereof. In certain embodiments, an organic protective layer includes a conductive monomer, oligomer, or polymer selected from poly(p-phenylene), polyacetylene, poly(p-phenylene vinylene), polyaniline, polypyrrole, polythiophene, poly(2,5-ethylene vinylene), acetylene, poly(perinaphthalene), polyacene, and poly(naphthalene-2,6-di-y1), or combinations thereof.

Moreover, in certain embodiments, inactive sulfur material, generated from an electroactive sulfur material of a cathode, during charging and discharging of a lithium-sulfur battery, attaches to an anode surface. The term “inactive sulfur”, as used herein, refers to sulfur that has no activity upon repeated electrochemical and chemical reactions, such that it cannot participate in an electrochemical reaction of a cathode. In certain embodiments, inactive sulfur on an anode surface acts as a protective layer on such electrode. In certain embodiments, inactive sulfur is lithium sulfide.

It is further contemplated that the present disclosure can be adapted for use in sodium-sulfur batteries. Such sodium-sulfur batteries comprise a sodium-based anode, and are encompassed within the scope of present disclosure.

### E. Preparation of Electrodes

There are a variety of methods for manufacturing electrodes for use in a lithium-sulfur battery. One process, such as a “wet process,” involves adding an active material, a binder and a conducting material (i.e., a cathode mixture) to a liquid to prepare a slurry composition. These slurries are typically in the form of a viscous liquid that is formulated to facilitate a downstream coating operation. A thorough mixing of a slurry can be important for coating and drying operations, which affect performance and quality of an electrode. Suitable mixing devices include ball mills, magnetic stirrers, sonication, planetary mixers, high speed mixers, homogenizers, universal type mixers, and static mixers. A liquid used to make a slurry can be one that homogeneously disperses an active material, a binder, a conducting material, and any additives, and that is easily evaporated. Suitable slurry liquids include, for example, N-methylpyrrolidone, acetonitrile, methanol, ethanol, propanol, butanol, tetrahydrofuran, water, isopropyl alcohol, dimethylpyrrolidone, and the like.

In some embodiments, a prepared composition is coated on a current collector and dried to form an electrode. Specifically, a slurry is used to coat an electrical conductor to form an electrode by evenly spreading a slurry on to a conductor, which is then, in certain embodiments, roll-pressed (e.g. calendared) and heated as is known in the art. Generally, a matrix of an active material and conductive material is held together and on to a conductor by a binder. In certain embodiments, a matrix comprises a lithium conducting polymer binder, such as polyvinylidene fluoride (PVDF), poly(vinylidene fluoride-co-hexafluoropropene) (PVDF/HFP), Polytetrafluoroethylene (PTFE), Kynar Flex® 2801, Kynar® Powerflex LBG, Kynar® HSV 900, Teflon®, styrene butadiene rubber (SBR), polyethylene oxide (PEO), or polytetrafluoroethylene (PTFE). In certain embodiments, additional carbon particles, carbon nanofibers, carbon nanotubes, are dispersed in a matrix to improve electrical conductivity. Alternatively or additionally, in certain embodiments, lithium ions are dispersed in a matrix to improve lithium conductivity.

In certain embodiments, a current collector is selected from the group consisting of: aluminum foil, copper foil, nickel foil, stainless steel foil, titanium foil, zirconium foil, molybdenum foil, nickel foam, copper foam, carbon paper or fiber sheets, polymer substrates coated with conductive metal, and/or combinations thereof.

PCT Publication Nos. WO2015/003184, WO2014/074150, and WO2013/040067, the entire disclosures of which are hereby incorporated by reference herein, describe various methods of fabricating electrodes and electrochemical cells.

### F. Separator

In certain embodiments, a lithium-sulfur battery comprises a separator, which divides an anode and cathode. In certain embodiments, a separator is an impermeable material substantially, or completely, impermeable to electrolyte. In certain embodiments, a separator is impermeable to polysulfide ions dissolved in electrolyte. In certain embodiments, a separator as a whole is impermeable to electrolyte, such that passage of electrolyte-soluble sulfides is blocked. In some embodiments, a degree of ionic conductivity across a separator is provided, for example via apertures in such separator. In certain such embodiments, a separator as a whole inhibits or restricts passage of electrolyte-soluble sulfides between anodic and cathodic portions of a battery as a result of its impermeability. In certain embodiments, a separator of impermeable material is configured to allow lithium ion transport between anode and cathode of a battery during charging and discharging of a cell. In some such embodiments, a separator does not completely isolate an anode and a cathode from each other. One or more electrolyte-permeable channels bypassing or penetrating through apertures in an impermeable face of a separator must be provided to allow sufficient lithium ion flux between anodic and cathodic portions of a battery. In some embodiments, where a separator is itself completely impermeable, a channel is provided through an annulus between a periphery of a separator and walls of a battery case.

It will be appreciated by a person skilled in the art that optimal dimensions of a separator must balance competing imperatives: maximum impedance to polysulfide migration while allowing sufficient lithium ion flux. Aside from this consideration, shape and orientation of a separator is not particularly limited, and depends in part on battery configuration. For example, a separator may be substantially circular in a coin-type cell, and substantially rectangular in a pouch-type cell. As described herein, a surface of a separator may be devoid of apertures, so that lithium ion flux occurs exclusively around edges of an impermeable sheet. However, certain embodiments are also contemplated in which some or all of a required lithium ion flux is provided through apertures in a separator. In some embodiments, a separator is substantially flat. However, it is not excluded that curved or other non-planar configurations may be used.

A separator may be of any suitable thickness. In order to maximize energy density of a battery, it is generally preferred that a separator is as thin and light as possible. However, a separator should be thick enough to provide sufficient mechanical robustness and to ensure suitable impermeability. In certain embodiments, a separator has a thickness of from about 1 micron to about 200 microns, preferably from about 5 microns to about 100 microns, more preferably from about 10 microns to about 30 microns.

### G. Electrolyte

In certain embodiments, a lithium-sulfur battery comprises an electrolyte comprising an electrolytic salt. Examples of electrolytic salts include, for example, lithium trifluoromethane sulfonimide, lithium triflate, lithium perchlorate, LiPF₆, LiBF₄, tetraalkylammonium salts (e.g. tetrabutylammonium tetrafluoroborate, TBABF₄), liquid state salts at room temperature (e.g. imidazolium salts, such as 1-ethyl-3-methylimidazolium bis-(perfluoroethyl sulfonyl)imide, EMIBeti), and the like.

In certain embodiments, an electrolyte comprises one or more alkali metal salts. In certain embodiments, such salts comprise lithium salts, such as LiCF₃SO₃, LiClO₄, LiNO₃, LiPF₆, and LiTFSI, or combinations thereof. In certain embodiments, an electrolyte comprises ionic liquids, such as 1-ethyl-3-methylimidzaolium-TFSI, N-butyl-N-methyl-piperidinium-TFSI, N-methyl-n-butyl pyrrolidinium-TFSI, and N-methyl-N-propylpiperidinium-TFSI, or combinations thereof. In certain embodiments, an electrolyte comprises supertonic conductors, such as sulfides, oxides, and phosphates, for example, phosphorous pentasulfide, or combinations thereof.

In certain embodiments, an electrolyte is a liquid. For example, in certain embodiments, an electrolyte comprises an organic solvent. In certain embodiments, an electrolyte comprises only one organic solvent. In some embodiments, an electrolyte comprises a mixture of two or more organic solvents. In certain embodiments, a mixture of organic solvents comprises organic solvents from at least two groups selected from weak polar solvent groups, strong polar solvent groups, and lithium protection groups.

The term “weak polar solvent”, as used herein, is defined as a solvent that is capable of dissolving elemental sulfur and has a dielectric coefficient of less than 15. A weak polar solvent is selected from aryl compounds, bicyclic ethers, and acyclic carbonate compounds. Examples of weak polar solvents include xylene, dimethoxyethane, 2-methyltetrahydrofuran, diethyl carbonate, dimethyl carbonate, toluene, dimethyl ether, diethyl ether, diglyme, tetraglyme, and the like. The term “strong polar solvent”, as used herein, is defined as a solvent that is capable of dissolving lithium polysulfide and has a dielectric coefficient of more than 15. A strong polar solvent is selected from bicyclic carbonate compounds, sulfoxide compounds, lactone compounds, ketone compounds, ester compounds, sulfate compounds, and sulfite compounds. Examples of the strong polar solvents include hexamethyl phosphoric triamide, γ-butyrolactone, acetonitrile, ethylene carbonate, propylene carbonate, N-methylpyrrolidone, 3-methyl-2-oxazolidone, dimethyl formamide, sulfolane, dimethyl acetamide, dimethyl sulfoxide, dimethyl sulfate, ethylene glycol diacetate, dimethyl sulfite, ethylene glycol sulfite, and the like. The term “lithium protection solvent”, as used herein, is defined as a solvent that forms a good protective layer, i.e. a stable solid-electrolyte interface (SEI) layer, on a lithium surface, and which shows a cyclic efficiency of at least 50%. A lithium protection solvent is selected from saturated ether compounds, unsaturated ether compounds, and heterocyclic compounds including one or more heteroatoms selected from the group consisting of N, O, and/or S. Examples of lithium protection solvents include tetrahydrofuran, 1,3-dioxolane, 3,5-dimethylisoxazole, 2,5-dimethyl furan, furan, 2-methyl furan, 1,4-oxane, 4-methyldioxolane, and the like.

In certain embodiments, an organic solvent comprises an ether. In certain embodiments, an organic solvent is selected from the group consisting of 1,3-dioxolane, dimethoxyethane, diglyme, triglyme, γ-butyrolactone, γ-valerolactone, and combinations thereof. In certain embodiments, an organic solvent comprises a mixture of 1,3-dioxolane and dimethoxyethane. In certain embodiments, an organic solvent comprises a 1:1 v/v mixture of 1,3-dioxolane and dimethoxyethane. In certain embodiments, an organic solvent is selected from the group consisting of: diglyme, triglyme, γ-butyrolactone, γ-valerolactone, and combinations thereof. In certain embodiments, an electrolyte comprises sulfolane, sulfolene, dimethyl sulfone, or methyl ethyl sulfone. In some embodiments, an electrolyte comprises ethylene carbonate, propylene carbonate, dimethyl carbonate, diethyl carbonate, or methylethyl carbonate.

In certain embodiments, an electrolyte comprises a liquid (e.g., an organic solvent). In some embodiments, a liquid is selected from the group consisting of organocarbonates, ethers, sulfones, water, alcohols, fluorocarbons, or combinations of any of these. In certain embodiments, an electrolyte comprises an ethereal solvent. In certain embodiments, an electrolyte comprises a liquid selected from the group consisting of sulfolane, sulfolene, dimethyl sulfone, and methyl ethyl sulfone. In certain embodiments, an electrolyte comprises a liquid selected from the group consisting of ethylene carbonate, propylene carbonate, dimethyl carbonate, diethyl carbonate, and methylethyl carbonate.

In certain embodiments, an electrolyte is a solid. In certain embodiments, a solid electrolyte comprises a polymer. In certain embodiments, a solid electrolyte comprises a glass, a ceramic, an inorganic composite, or combinations thereof.

### H. Lithium-Sulfur Battery

In one aspect, the present disclosure is directed to a secondary lithium-sulfur battery comprising a sulfur-containing cathode, a lithium-containing anode, and an electrolyte ionically coupling anode and cathode.

In one aspect, the present disclosure provides lithium-sulfur batteries containing coated sulfur nanoparticles described herein. For example, in certain embodiments, such batteries include a lithium-containing anode composition coupled to a cathode composition comprising sulfur nanoparticles described herein. In some embodiments, such batteries also comprise additional components such as separators between the anode and cathode, anodic and cathodic current collectors, terminals by which the cell can be coupled to an external load, and packaging such as a flexible pouch or a rigid metal container. It is further contemplated that the present disclosure regarding lithium-sulfur batteries can be adapted for use in sodium-sulfur batteries, and such batteries are also considered within the scope of the present disclosure.

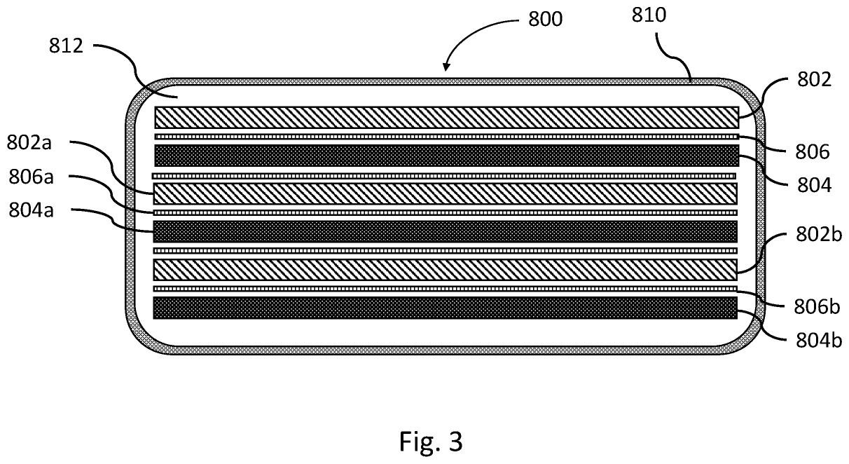

FIG. 3 illustrates a cross section of an electrochemical cell 800 in accordance with certain exemplary embodiments of the present disclosure. Electrochemical cell 800 includes a negative electrode 802, a positive electrode 804, a separator 806 interposed between negative electrode 802 and positive electrode 804, a container 810, and a fluid electrolyte 812 in contact with negative and positive electrodes 802, 804. Such cells optionally include additional layers of electrode and separators 802a, 802b, 804a, 804b, 806a, and 806b.

Negative electrode 802 (also sometimes referred to herein as an anode) comprises a negative electrode active material that can accept cations. Non-limiting examples of negative electrode active materials for lithium-based electrochemical cells include Li metal, Li alloys such as those of Si, Sn, Bi, In, and/or Al, Li₄Ti₅O₁₂, hard carbon, graphitic carbon, metal chalcogenides, and/or amorphous carbon. In accordance with some embodiments of the disclosure, most (e.g., greater than 90 wt. %) of an anode active material can be initially included in a discharged positive electrode 804 (also sometimes referred to herein as a cathode) when electrochemical cell 800 is initially made, so that an electrode active material forms part of first electrode 802 during a first charge of electrochemical cell 800.

A technique for depositing electroactive material on a portion of negative electrode 802 is described in U.S. Patent Publication No. 2016/0172660, in the name of Fischer et al., and similarly in U.S. Patent Publication No. 2016/0172661, in the name of Fischer et al., the contents of which are hereby incorporated herein by reference, to the extent such contents do not conflict with the present disclosure.

Negative electrode 802 and positive electrode 804 can further include one or more electrically conductive additives as described herein. In accordance with some embodiments of the disclosure, negative electrode 802 and/or positive electrode 804 further include one or more polymer binders as described herein.

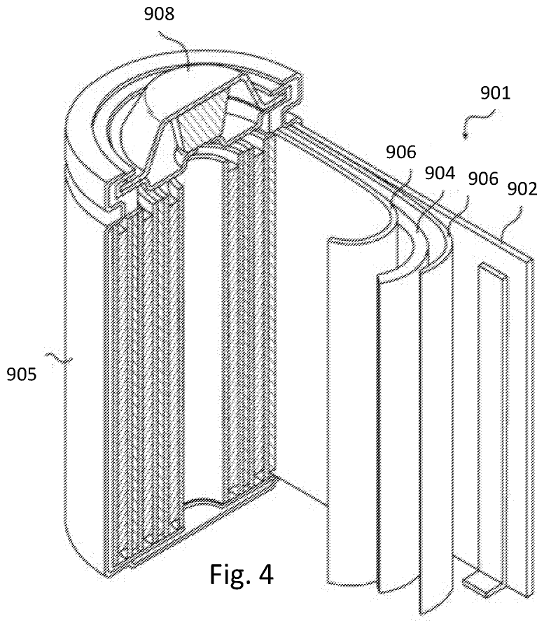

FIG. 4 illustrates an example of a battery according to certain embodiments described herein. A cylindrical battery is shown here for illustration purposes, but other types of arrangements, including prismatic or pouch (laminate-type) batteries, may also be used as desired. Exemplary Li battery 901 includes anode 902, cathode 904, a separator 906 interposed between anode 902 and cathode 904, an electrolyte (not shown) impregnating the separator 906, a battery case 905, and a sealing member 908 sealing the battery case 905. It will be appreciated that example battery 901 may simultaneously embody multiple aspects of the present disclosure in various designs.

A lithium-sulfur battery of the present disclosure comprises a lithium anode, a sulfur-based cathode, and an electrolyte permitting lithium ion transport between anode and cathode. In certain embodiments, described herein, an anodic portion of a battery comprises an anode and a portion of electrolyte with which it is in contact. Similarly, in certain embodiments, described herein, a cathodic portion of a battery comprises a cathode and a portion of electrolyte with which it is in contact. In certain embodiments, a battery comprises a lithium ion-permeable separator, which defines a boundary between an anodic portion and a cathodic portion. In certain embodiments, a battery comprises a case, which encloses both anodic and cathodic portions. In certain embodiments, a battery case comprises an electrically conductive anodic-end cover in electrical communication with an anode, and an electrically conductive cathodic-end cover in electrical communication with a cathode to facilitate charging and discharging via an external circuit.

### IV. EXAMPLES

The following examples embody certain compositions and methods of the present disclosure and demonstrate fabrication of lithium-sulfur batteries according to certain embodiments herein. Moreover, the following examples are included to demonstrate the principles of the disclosed compositions and methods and are not intended as limiting.

### Example 1: Preparation of Coated Sulfur Nanoparticles (CSPs)

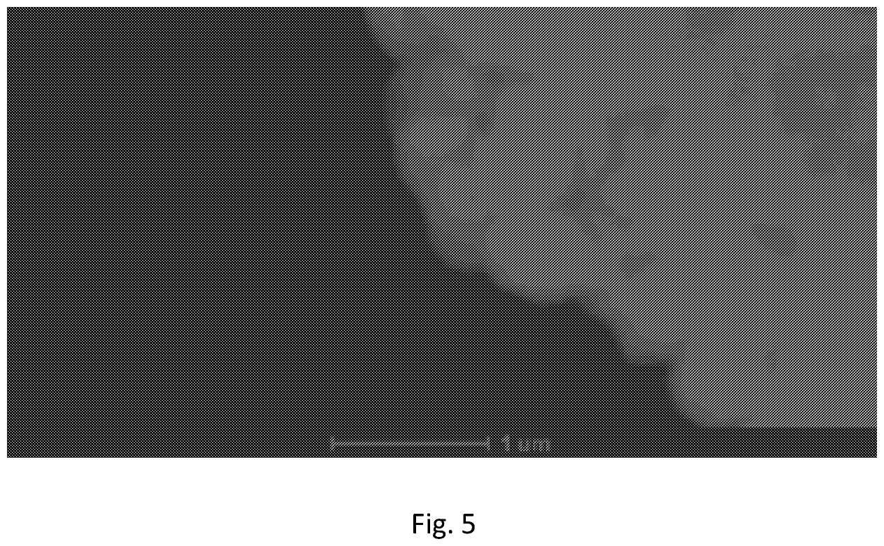

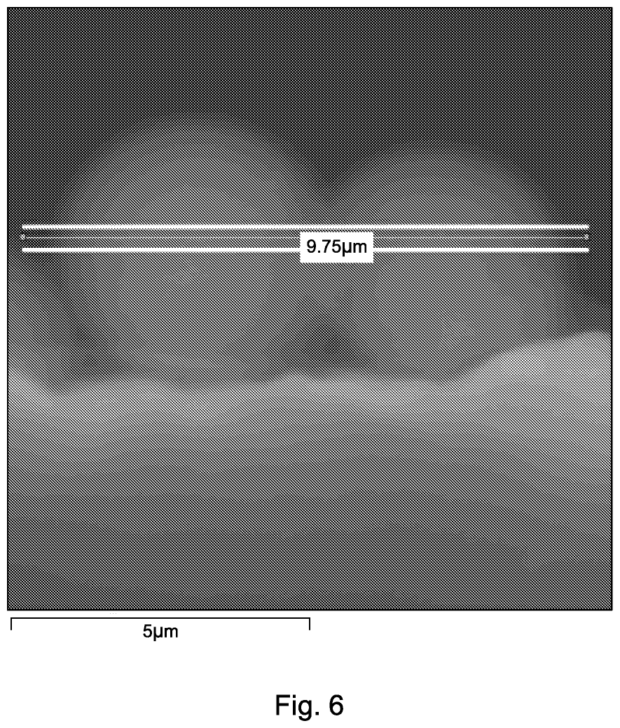

Polyaniline-coated sulfur particles are heated for 12 hours at 200° C. in an argon-purged stainless-steel vessel. During the heating period, sulfur vapor reacts with the polyaniline coating to form a vulcanized polyaniline coating. As shown in FIGS. 5 and 6, when the particles are imaged by cryogenic TEM (cryo-TEM), the CSPs exhibit a uniform intensity, indicating no gap between the sulfur nanoparticle and the coating. Cryo-TEM is particularly useful to fully image the internal sulfur structure because the sulfur is not affected by the vacuum of the instrument while the material is at very low cryogenic temperatures.

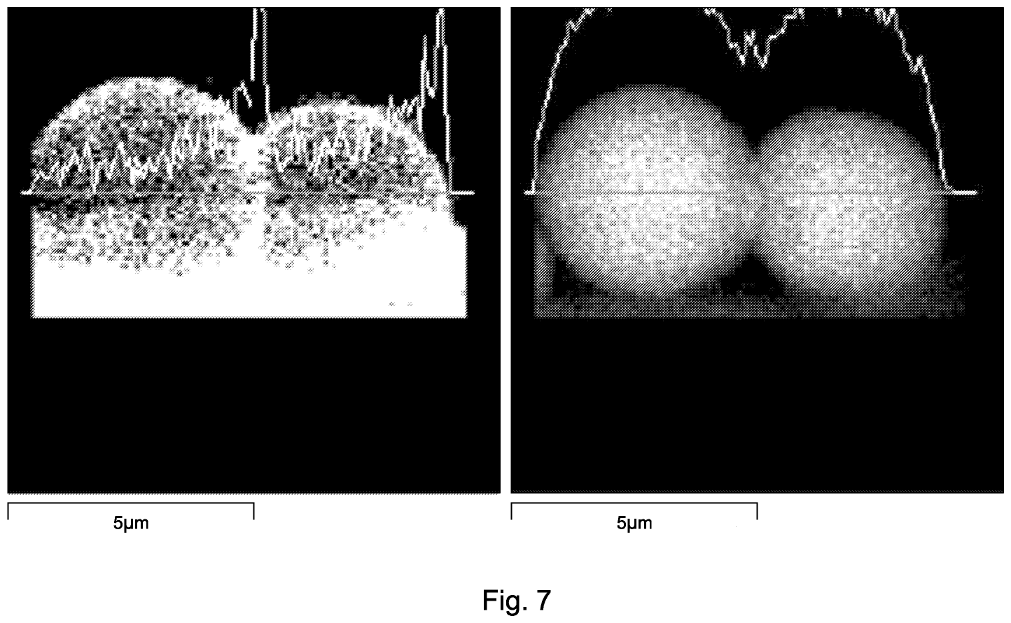

The absence of a gap between nanoparticle and coating is further confirmed by elemental mapping using Energy Dispersive X-ray Spectroscopy (EDS), which shows uniform sulfur density across the inside of the coated particles (FIG. 7).

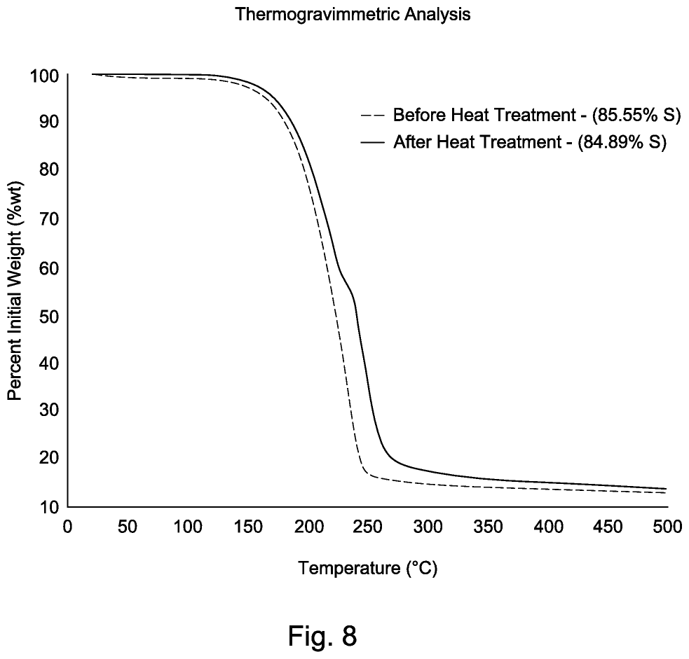

Thermogravimetric analysis, depicted in FIG. 8, indicates 1) a high sulfur content; and 2) minimal change in sulfur content post-vulcanization, which provides further evidence that the CSPs are completely filled with sulfur, with no gap between the nanoparticle and its coating.

It will be appreciated that in other embodiments, other vulcanizable polymers can provide a polymer shell, and that a variety of conditions can be used to carry out vulcanization.

1. A composition comprising:
a sulfur nanoparticle; and
a polymer shell wherein there is no gap between the sulfur nanoparticle and the polymer shell.

2. A composition comprising:
a sulfur nanoparticle; and
a vulcanized polymer shell wherein there is no gap between the sulfur nanoparticle and the vulcanized polymer shell.

3. The composition of claim 2, wherein the vulcanized polymer shell comprises a vulcanized polymer selected from the group consisting of vulcanized polyaniline, vulcanized polythiophene, vulcanized polyacetylene, vulcanized polypyrrole, vulcanized polydopamine, and blends, mixtures, and co-polymers thereof.

4. The composition of claim 2, wherein the vulcanized polymer shell comprises vulcanized polyaniline.

5. The composition of claim 1 or 2, wherein the polymer shell comprises a polymer selected from the group consisting of polyaniline, polythiophene, polyacetylene, polypyrrole, polydopamine, and mixtures, co-polymers, and blends thereof.

6. The composition of claim 5, wherein the polymer shell comprises polyaniline.

7. The composition of any one of the preceding claims, wherein the sulfur nanoparticle comprises sulfur in the form of elemental sulfur, sulfur-containing organic molecules, sulfur-containing polymers, sulfur-containing composites, metal sulfides, or combinations or composites thereof.

8. The composition of claim 7, wherein the sulfur nanoparticle comprises elemental sulfur.

9. The composition of any one of claims 1 to 6, wherein the sulfur nanoparticle does not comprise Li₂S.

10. The composition of any one of the preceding claims, wherein the absence of a gap between the sulfur nanoparticle and the polymer shell is determined by cryogenic TEM.

11. A method comprising:
providing a nanostructured electroactive sulfur material;
contacting the nanostructured electroactive sulfur material with a polymerization mixture, comprising a mixture of monomers, under conditions that promote polymerization to produce a conductive polymer shell; and
vulcanizing the polymer shell by cross-linking the polymer shell with sulfur from the electroactive sulfur material, wherein there is no gap between the electroactive sulfur material and the polymer shell after vulcanization.

12. A method comprising:
providing a sulfur nanoparticle;
coating the sulfur nanoparticle with a polymer shell;
vulcanizing the sulfur nanoparticle and polymer shell by cross-linking the polymer with the sulfur, wherein there is no gap between the sulfur nanoparticle and the polymer shell after vulcanization.

13. The method of claim 11 or 12, wherein vulcanizing the sulfur nanoparticle and polymer shell includes heating the sulfur nanoparticle to cross-link the polymer shell.

14. The method of claim 13, wherein the sulfur nanoparticle is heated to a temperature within a range of 80° C. to 400° C.

15. The method of claim 13 or 14, wherein the sulfur nanoparticle is heated for 0.2 to 48 hours.

16. The method of any one of claims 11 to 15, wherein the polymer shell is a polyaniline shell.

17. The method of any one of claims 11 to 15, wherein the polymer shell comprises a polymer selected from the group consisting of polyaniline, polythiophene, polyacetylene, polypyrrole, polydopamine, and mixtures, co-polymers, and blends thereof.

18. The method of any one of claims 12 to 17, wherein the sulfur nanoparticle comprises elemental sulfur, sulfur-containing organic molecules, sulfur-containing polymers, sulfur-containing composites, metal sulfides, or combinations or composites thereof.

19. The method of any one of claims 12 to 17, wherein the sulfur nanoparticle does not comprise Li₂S.

20. The method of claim 11, wherein the electroactive sulfur material comprises elemental sulfur, sulfur-containing organic molecules, sulfur-containing polymers, sulfur-containing composites, metal sulfides, or combinations or composites thereof.

21. The method of claim 11, wherein the electroactive sulfur material does not comprise Li₂S.

22. The method of any one of claims 11 to 21, wherein the absence of a gap between the electroactive sulfur material/sulfur nanoparticle and the polymer shell is determined by cryogenic TEM.

23. A nanostructured material comprising:
a polymer shell; and
a contained electroactive sulfur material.

24. The nanostructured material of claim 23, wherein the polymer shell comprises a polymer selected from the group consisting of polyaniline, polythiophene, polyacetylene, polypyrrole, polydopamine, and mixtures, co-polymers, and blends thereof.

25. The nanostructured material of claim 24, wherein the polymer shell comprises polyaniline.

26. The nanostructured material of claim 23 or 24, wherein the polymer shell comprises a vulcanized polymer.

27. The nanostructured material of claim 26, wherein the vulcanized polymer is selected from the group consisting of polyolefins, polyalkynes, polyaromatic and polyheteroaromatic polymers, and blends, mixtures, and co-polymers thereof.

28. The nanostructured material of claim 26, wherein the vulcanized polymer is selected from a vulcanized composition derived from the group consisting of: polyaniline, polythiophene, polyacetylene, polypyrrole, polydopamine, and blends, mixtures, and co-polymers thereof.

29. The nanostructured material of claim 26, wherein the vulcanized polymer is selected from the group consisting of vulcanized polyaniline, vulcanized polythiophene, vulcanized polyacetylene, vulcanized polypyrrole, vulcanized polydopamine, and blends, mixtures, and co-polymers thereof.

30. The nanostructured material of any one of claims 26 to 29, wherein the vulcanized polymer comprises vulcanized polyaniline.

31. The nanostructured material of any one of claims 26 to 29, wherein the vulcanized polymer comprises vulcanized polythiophene.

32. The nanostructured material of any one of claims 26 to 29, wherein the vulcanized polymer comprises vulcanized polypyrrole.

33. The nanostructured material of any one of claims 26 to 29, wherein the vulcanized polymer comprises vulcanized polyacetylene.

34. The nanostructured material of any one of claims 26 to 29, wherein the vulcanized polymer comprises vulcanized polydopamine.

35. The nanostructured material of any one of claims 23 to 34, wherein the contained electroactive sulfur material comprises sulfur in the form of elemental sulfur, sulfur-containing organic molecules, sulfur-containing polymers, sulfur-containing composites, metal sulfides, or combinations or composites thereof.

36. The nanostructured material of claim 35, wherein the contained electroactive sulfur material comprises elemental sulfur.

37. The nanostructured material of claim 35 or 36, wherein the contained electroactive sulfur material does not comprise Li₂S.

38. The nanostructured material of any one of claims 23 to 37, wherein there is no gap between the contained electroactive sulfur material and the polymer shell.

39. The nanostructured material of claim 38, wherein the absence of a gap between the contained electroactive sulfur material and the polymer shell is determined by cryogenic TEM.

40. A cathode mixture comprising the composition of any one of claims 1 to 10, a conductive additive, and a binder.

41. A cathode mixture comprising the nanostructured material of any one of claims 23 to 39, a conductive additive, and a binder.

42. A secondary lithium-sulfur battery comprising a cathode prepared with the cathode mixture of claim 40 or 41, a lithium-containing anode, and an electrolyte ionically coupling the anode and the cathode.
